(19) United States
(12) Patent Application Publication
(10) Pub. No.: US 2024/0271405 A1
(43) Pub. Date: Aug. 15, 2024

(54) TOILET

(71) Applicant: Jiandong Wang, Rizhao City, Shandong Province (CN)

(72) Inventors: Jiandong Wang, Rizhao City (CN); Ying Dong, Chuzhou City (CN)

(21) Appl. No.: 18/432,329

(22) Filed: Feb. 5, 2024

(30) Foreign Application Priority Data
Feb. 10, 2023 (CN) 202320208014.7
Feb. 10, 2023 (CN) 202320208054.1
Mar. 20, 2023 (CN) 202320569607.6

(51) Int. Cl. E03D 11/00

(52) U.S. Cl. CPC E03D 11/00

(57) ABSTRACT

A toilet, including: a base, wherein a holding cavity is defined inside the base; a toilet seat, arranged on the base; and a biodegradation container, wherein an interior of the biodegradation container is filled with a biodegradation filler, the biodegradation container being movably disposed within the holding cavity and configured to receive excrement from the toilet seat and to decompose the excrement.

### CROSS REFERENCE TO RELATED APPLICATIONS

The present application claims foreign priority of Chinese Patent Application No. 202320208014.7, filed on Feb. 10, 2023; No. 202320208054.1, filed on Feb. 10, 2023; and No. 202320569607.6, filed on Mar. 20, 2023; in the China National Intellectual Property Administration, the entire contents of which are hereby incorporated by reference in its entirety.

### TECHNICAL FIELD

The present disclosure relates to the field of sanitary technologies, and especially relates to a toilet.

### BACKGROUND

Microbial toilets are a new type of toilet that has recently emerged. Compared to flush toilets, the microbial toilets can utilize microbial degradation strains to ferment and compost excrement without the need for water flushing, which are suitable for applications in places of use where water supply is inconvenient (e.g., RVs or areas where water is scarce).

However, a toilet base in the related art is large in size, which increases the occupied area of the toilet, and there is also the problem of inconvenient operation when replacing the microbial degradation bacteria strains.

In addition, in some cases, a small amount of feces or urine may remain on the toilet, requiring the toilet to be flushed. The problem to be solved is how to avoid flushing water from flowing into a biodegradation tank containing the microbial degradation strains and reducing the activity of the microbial degradation strains.

### SUMMARY OF THE DISCLOSURE

Based on this, it is necessary to propose a novel toilet to solve the above technical problems.

The present disclosure provides a toilet, including: a base, wherein a holding cavity is defined inside the base; a toilet seat, arranged on the base; and a biodegradation container, wherein an interior of the biodegradation container is filled with a biodegradation filler, the biodegradation container being movably disposed within the holding cavity and configured to receive excrement from the toilet seat and to decompose the excrement.

In some embodiments, a top surface of the base defines a top opening in communication with the holding cavity; the toilet seat includes a seat body and a toilet tank, the seat body being arranged on the base; the seat body defines a channel in communication with the top opening and a holding groove arranged around the channel; the toilet tank is arranged on the seat body, and the toilet tank is formed with a urine hopper for collecting urine and a fecal discharge groove in communication with the channel; the urine hopper defines a urine drainage outlet for discharging the urine into the holding groove.

In some embodiments, the seat body is configured to be rotatably disposed on the base around the top opening.

In some embodiments, the base defines a first arcuate groove around the top opening, the first arcuate groove having a liquid drainage outlet; a bottom wall of the holding groove has a through hole, and the seat body further includes a dispensing tube section extending downwardly from the bottom wall of the holding groove into the first arcuate groove; liquid in the holding groove is capable of entering the first arcuate groove through the dispensing tube section and discharged outwardly through the liquid drainage outlet; the dispensing tube section remains disposed within the first arcuate groove in condition of the seat body rotating around the top opening.

In some embodiments, the seat body includes: a shell, having an upper opening for connecting to the toilet tank and a lower opening for facing the top opening; a barrel, defining the channel and formed on an inside of the lower opening; an annular plate, connected to the barrel and the shell; and a ribbed plate, extending upwardly over at least a portion of a radially outer edge of the annular plate, to define the holding groove in conjunction with the annular plate, the barrel, and the shell.

In some embodiments, the annular plate is connected a lower portion of the barrel and a lower portion of the shell; the lower portion of the barrel, the lower portion of the shell, and the annular plate together define an annular groove with a downward-facing opening, and the first arcuate groove is disposed within the annular groove.

In some embodiments, the base further defines a second arcuate groove around the top opening, the second arcuate groove facing the first arcuate groove; the second arcuate groove and the first arcuate groove are both disposed within the annular groove.

In some embodiments, the seat body further includes a restriction ring detachably connected to a bottom of the channel, the restriction ring being disposed within the holding cavity; a diameter of the top opening is less than an outer diameter of the restriction ring and greater than an inner diameter of the restriction ring.

In some embodiments, the holding groove is arranged with filter material capable of filtering urine.

In some embodiments, the toilet further includes: a mixing portion, configured to mix the biodegradation filler within the biodegradation container; wherein the mixing portion includes a mixing shaft and a joint connected to the mixing shaft, the joint being arranged on an outer side of a peripheral wall of the biodegradation container; and a driving portion, arranged on the base opposite the joint in the holding cavity for driving the mixing portion to rotate; wherein the driving portion includes a joint fit portion to be plugged and mated with the joint; in response to the biodegradation container being moved in a direction proximate to the driving portion, the joint fit portion is plugged and mated with the joint; in response to the biodegradation container being moved in a direction away from the driving portion, the joint fit portion is disengaged from the joint.

In some embodiments, the joint is a first end gear, and an end surface of the first end gear back away from the mixing shaft is arranged with first end teeth; the joint fit portion is a second end gear, and an end surface of the second end gear facing the first end teeth is arranged with second end teeth; in condition of the first end teeth being plugged and mated with the second end teeth axially, the second end teeth mesh with the first end teeth.

In some embodiments, the biodegradation container is arranged with a guide portion, and a cavity wall of the holding cavity is arranged with a guide fit portion to match with the guide portion; the joint fit portion is configured to be aligned with the joint through a guiding action of the guide portion and the guide fit portion.

In some embodiments, the holding cavity has a lateral opening in a predetermined direction; the guide portion is a guiding slot or a guiding protrusion arranged on a bottom of the biodegradation container extending in the predetermined direction, and the guide fit portion is a guiding protrusion or a guiding slot arranged on a bottom wall of the holding cavity extending in the predetermined direction; the biodegradation container is configured to enter the holding cavity through the lateral opening.

In some embodiments, the mixing shaft includes two mixing shafts; the joint includes two joints, and the joint fit portion includes two joint fit portions; the two joint fit portions are plugged and mated with the two joints in a one-to-one correspondence; the driving portion further includes: a motor connected to the two joint fit portions through a synchronous belt pulley; the motor and the two joint fit portions are arranged on the bottom wall of the holding cavity.

In some embodiments, the toilet seat is arranged with a channel running up and down; a top surface of the base defines a top opening in communication with the holding cavity, the channel being connected to the top opening; the biodegradation container further includes: a body and a cover, the cover being detachably connected to the body, the cover having a container opening for aligning with the top opening to receive excrement from the channel; the toilet further includes: a baffle assembly for operably opening or closing the top opening.

In some embodiments, the baffle assembly includes: two baffle slides, disposed opposite each other on a perimeter wall of the base; a baffle, slidably disposed on the two baffle slides; two link assemblies, disposed on both sides of the baffle; a linkage member, connected to the two linkage assemblies; and a toggle member, connected to the linkage member; in response to the toggle member being toggled, the linkage member and the two link assemblies drive the baffle to slide relative to the two baffle slides, thereby opening or closing the top opening.

The present disclosure further provides a toilet, including: a base, wherein a holding cavity is defined inside the base; a toilet seat, arranged on the base and defining a fecal discharge channel for receiving excrement; a biodegradation container, arranged in the holding cavity for receiving the excrement from the fecal discharge channel and decomposing the excrement; and a liquid collection tray, arranged in the holding cavity and configured to be operable to be in a first position staggered from the fecal discharge channel or in a second position facing the fecal discharge channel; wherein in response to the liquid collection tray being in the first position, the excrement from the fecal discharge channel is allowed to enter the biodegradation container; in response to the liquid collection tray being in the second position, the liquid collection tray is capable of receiving liquid from the fecal discharge channel.

In some embodiments, the toilet further includes: a liquid collection container, arranged within the holding cavity; the liquid received by the liquid collection tray is capable of flowing into the liquid collection container.

In some embodiments, an opening is defined on a top of the liquid collection container; the liquid collection tray includes: a tray body and a deflector groove in communication with the tray body; in response to the liquid collection tray being in the second position, the tray body is disposed directly below the fecal discharge channel, and an outlet of the deflector groove is disposed directly above the opening of the liquid collection container.

In some embodiments, the tray body includes a tray base plate and a flange extending upwardly from a peripheral edge of the tray base plate; an upper surface of the tray base plate extends downwardly at an angle from a side away from the deflector groove toward the deflector groove.

In some embodiments, the toilet further includes: an operating assembly for driving the liquid collection tray to switch between the first position and the second position.

In some embodiments, the liquid collection tray includes a tray body and a connecting member disposed on a side of the tray body, the connecting member pivotally connected to the toilet base; the operating assembly includes: a first linkage member, a second linkage member, and a toggle member; the toggle member and the second linkage member are rigidly connected and pivotally connected to the toilet base; the first linkage member is pivotally connected to the connecting member and the second linkage member, respectively; in response to the toggle member being toggled, the first linkage member and the second linkage member drive the liquid collection tray to rotate with respect to the base such that the liquid collection tray is in the first position or the second position.

In some embodiments, the toilet further includes: a smart toilet lid, arranged on the toilet seat.

In some embodiments, the smart toilet lid includes a fecal flush port for providing flushing water to the fecal discharge channel.

In summary, the present disclosure provides a toilet, including: a base, wherein a holding cavity is defined inside the base; a toilet seat, arranged on the base; and a biodegradation container, wherein an interior of the biodegradation container is filled with a biodegradation filler, the biodegradation container being movably disposed within the holding cavity and configured to receive excrement from the toilet seat and to decompose the excrement.

The embodiments of the present disclosure may well realize the separation of urine and feces due to the separate provision of the urine hopper and the fecal discharge groove, which is conducive to the biodegradation of feces. Since the holding groove for collecting urine is arranged around the channel in the seat body, it does not occupy the space of the holding cavity, thereby not increasing the occupied area of the toilet.

In the toilet in the embodiments of the present disclosure, due to the provision of the joint connected to the mixing shaft on the outer side of the peripheral wall of the biodegradation container, the provision of the driving portion on the base, and the provision of the joint fit portion of the driving portion which is plugged and mated with the joint, the joint fit portion is plugged and mated with the joint when the biodegradation container is moved in the direction close to the driving portion, and the joint fit portion is disengaged from the joint when the biodegradation container is moved in the direction far away from the driving portion. In this way, when the materials are required to be replaced, it is only necessary to pull the biodegradation container in a direction away from the driving portion to disengage the connection between the driving portion and the mixing shaft. After the materials are replaced, the connection between the driving portion and the mixing shaft is established by pushing the biodegradation container in a direction towards the driving portion, which makes the operation very convenient.

By arranging the liquid collection tray, the embodiments of the present disclosure allow excrement from the fecal discharge channel to enter the biodegradation container when the toilet is used by having the liquid collection tray in the first position. After the toilet is used, when the toilet is flushed, by placing the liquid collection tray in the second position, the liquid collection tray can be utilized to receive the liquid from the fecal discharge channel in order to avoid the liquid from flowing into the biodegradation container and adversely affecting the biodegradation colonies of strains. The liquid collection tray, when in the second position, may further prevent odors in the biodegradation container from spreading outwardly, while making the toilet more aesthetically pleasing.

### BRIEF DESCRIPTION OF THE DRAWINGS

In order to more clearly illustrate the technical solutions in the specific embodiments of the present disclosure or the related art, the following will briefly introduce the accompanying drawings that need to be used in the specific embodiments or related art. It is obvious that the attached drawings in the following description are some of the embodiments of the present disclosure. For those skilled in the art, other accompanying drawings may be obtained from these drawings without creative effort.

FIG. 1 is a schematic structural view of a toilet according to some embodiments of the present disclosure.

FIG. 2 is a schematic structural view of the toilet shown in FIG. 1 at another viewing angle.

FIG. 3 is a schematic view of a partial decomposition of the toilet shown in FIG. 1.

FIG. 4 is a schematic view of an assembly of a driving portion and a mixing portion according to some embodiments of the present disclosure.

FIG. 5 is a front view of the toilet shown in FIG. 1.

FIG. 6 is a sectional schematic view along C-C in FIG. 5.

FIG. 7 is a schematic view of a partial decomposition of the toilet shown in FIG. 1.

FIG. 8 is a schematic structural view of a toilet tank shown in FIG. 7.

FIG. 9 is a schematic structural view of the toilet shown in FIG. 1 omitting a toilet lid and a toilet mat.

FIG. 10 is a schematic structural view of a seat shown in FIG. 7.

FIG. 11 is a schematic structural view of the toilet shown in FIG. 9 omitting a toilet tank.

FIG. 12 is a schematic structural view of a toilet according to other embodiments of the present disclosure.

FIG. 13 is a schematic view of a decomposition of the toilet shown in FIG. 1.

FIG. 14 is a schematic structural view of a toilet base shown in FIG. 1 and its internal members.

FIG. 15 is a schematic structural view of FIG. 14 with an upper shell of the toilet base omitted.

FIG. 16 is an enlarged schematic view of some of the members in FIG. 15.

FIG. 17 is a front view of the toilet shown in FIG. 1.

FIG. 18 is a sectional view of the toilet shown in FIG. 17 along A-A.

FIG. 19 is a sectional view of the toilet shown in FIG. 17 along B-B.

FIG. 20 is a partial schematic view of the toilet shown in FIG. 19.

FIG. 21 is a schematic structural view of a seat shown in FIG. 13 at a viewing angle.

FIG. 22 is a schematic structural view of a seat shown in FIG. 13 at another viewing angle.

FIG. 23 is a schematic structural view of a toilet tank shown in FIG. 13 at a viewing angle.

FIG. 24 is a schematic structural view of a toilet tank shown in FIG. 13 at another viewing angle.

It should be noted that the accompanying drawings are not drawn to scale, and that for illustrative purposes, elements of similar structure or function are generally represented throughout the accompanying drawings by similar reference numerals. It should also be noted that the accompanying drawings are intended only to facilitate the description of the embodiments and not the present disclosure itself. The accompanying drawings do not illustrate every aspect of the described embodiments and do not limit the scope of the present disclosure.

### REFERENCE NUMERALS

10, base; 101, holding cavity; 11, lateral opening; 12, bottom base; 121, guide fit portion; 122, bracket; 13, upper shell; 14, top opening; 15, first arcuate groove; 16, second arcuate groove;

20, toilet seat; 21, toilet lid; 22, toilet mat; 23, toilet tank; 231, fecal discharge groove; 232, urine hopper; 2321, urine drainage outlet; 24, seat body; 240, shell; 241, channel; 242, holding groove; 2421, through hole; 243, annular plate; 244, restriction ring; 245, annular groove; 246, dispensing tube section; 247, barrel; 248, ribbed plate;

30, biodegradation container; 31, cover; 311, container opening; 32, body; 321, guide portion; 33, carrying handle;

40, baffle assembly; 41, baffle; 42, baffle slide; 43, first link; 44, second link; 45, third link; 46, linkage member; 47, toggle member;

51, mixing shaft; 52, blade; 53, first end gear; 54, motor; 55, synchronous belt pulley; 56, second end gear;

10′, base; 101′, holding cavity; 11′, lateral opening; 12′, bottom base; 121′, bracket; 13′, upper shell; 14′, top opening; 15′, liquid transit groove; 151′, liquid drainage outlet; 16′, annular groove; 161′, spacer;

20′, toilet seat; 21′, seat body; 211′, central channel; 212′, urine filtering groove; 213′, dispensing tube section; 214′, annular restriction member 215′, annular groove; 22′, toilet tank; 221′, fecal discharge channel; 2211′, deflector groove; 222′, urine hopper; 2221′, urinary outlet; 2222′, urinal flush port; 2223′, strip reservoir; 2224′, urinal flush inlet;

30′, biodegradation container; 31′, cover; 311′, container opening; 32′, body; 33′, carrying handle;

41′, liquid collection tray; 411′, tray body; 4111′, tray base plate; 4112′, flange; 412′, deflector groove; 413′, connecting member; 42′, first linkage member; 43′, second linkage member; 44′, toggle member;

51′, mixing shaft; 52′, blade; 53′, first end gear; 54′, motor; 55′, synchronous belt pulley; 56′, second end gear;

61′, liquid collection container; 611′, opening;

70′, smart toilet lid; 71′, fecal flush port; 72′, fecal flush inlet.

### DETAILED DESCRIPTION

Embodiments of the present disclosure are described in detail below, and examples of the embodiments are shown in the accompanying drawings, where the same or similar symbols throughout denote the same or similar elements or elements having the same or similar functions. The embodiments described below by reference to the accompanying drawings are exemplary and are intended only for the purpose of interpreting the present disclosure and are not to be construed as a limitation of the present disclosure.

The following disclosure provides multiple different embodiments or examples to realize the present disclosure. In order to simplify the description of the present disclosure, the components and methods of particular examples are described below. They are, of course, examples only and are not intended to limit the present disclosure.

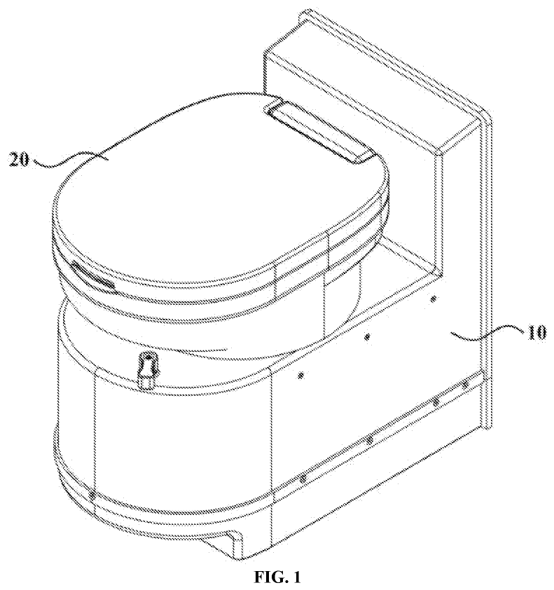

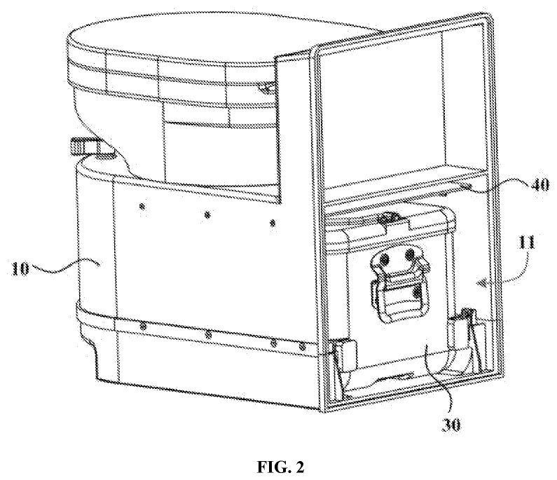

As shown in FIGS. 1 to 11, some embodiments of the present disclosure provide a toilet including: a base 10 and a toilet seat 20 disposed on the base 10. a holding cavity 101 is defined inside the base 10.

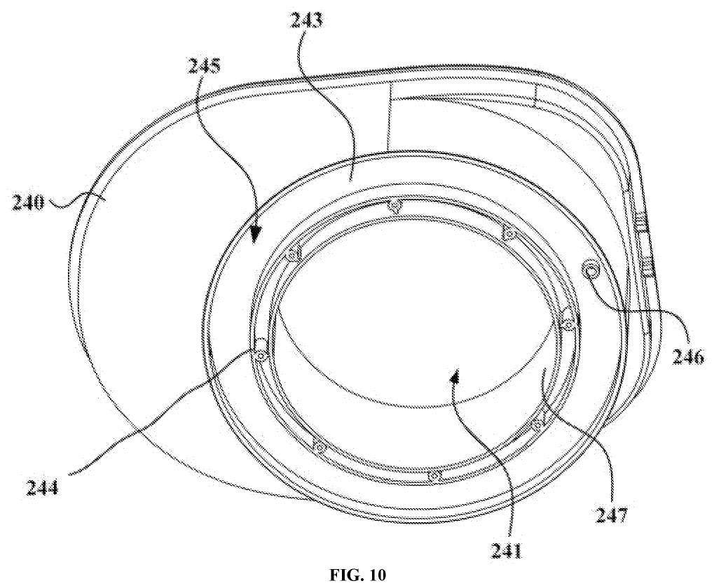

A top surface of the base 10 defines a top opening 14 in communication with the holding cavity 101. The toilet seat 20 may include: a seat body 24 and a toilet tank 23. The seat body 24 is arranged on the base 10. Referring to FIGS. 10 and 11, the seat body 24 defines a channel 241 in communication with the top opening 14 and a holding groove 242 arranged around the channel 241.

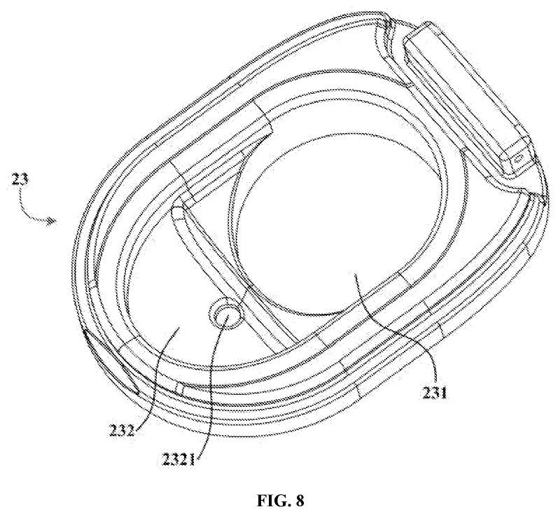

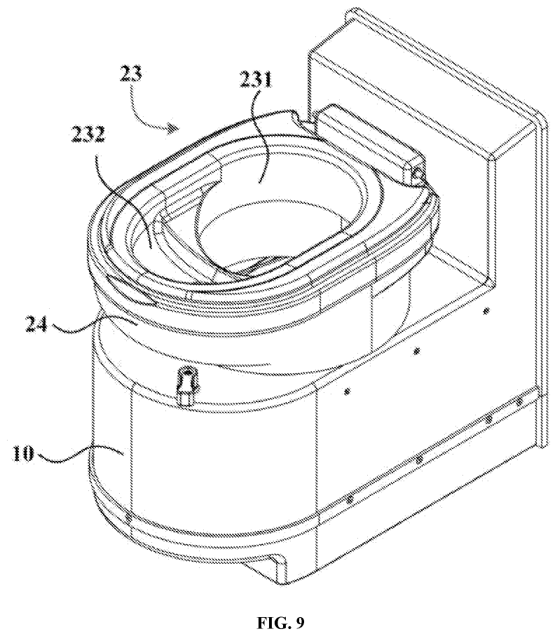

The toilet tank 23 is arranged on the seat body 24. Referring to FIGS. 8 and 9, the toilet tank 23 is formed with a urine hopper 232 for collecting urine and a fecal discharge groove 231 in communication with the channel 241. The urine hopper 232 defines a urine drainage outlet 2321 for discharging urine into the holding groove 242.

The embodiments of the present disclosure may well realize the separation of urine and feces due to the separate provision of the urine hopper 232 and the fecal discharge groove 231, which is conducive to the biodegradation of feces. Since the holding groove 242 for collecting urine is arranged around the channel 241 in the seat body 24, it does not occupy the space of the holding cavity 101, thereby not increasing the occupied area of the toilet.

The dimensions of the channel 241 may be set larger to avoid excrement remaining on the channel 241. In some embodiments, the diameter of the channel 241 may be substantially the same as a dimension in a width direction of the toilet mat 22 as mentioned below. In some embodiments, the diameter of the channel 241 is slightly greater than the dimension in the width direction of the toilet mat 22. For example, the diameter of the channel 241 may be 0.5-3 cm greater than the dimension in the width direction of the toilet mat 22.

In some embodiments, the seat body 24 is configured to be rotatably disposed on the base 10 around the top opening 14. When the seat body 24 rotates around the top opening 14, it rotates the entire toilet seat 20 together. In this way, the user can adjust the position of the toilet seat 20 as needed, making full use of space.

The seat body 24 further includes a restriction ring 244 detachably connected to a bottom of the channel 241, the restriction ring 244 being disposed in the holding cavity 101. The diameter of the top opening 14 is less than an outer diameter of the restriction ring 244 and greater than an inner diameter of the restriction ring 244. By arranging the restriction ring 244, the seat body 24 may be prevented from separating from the base 10.

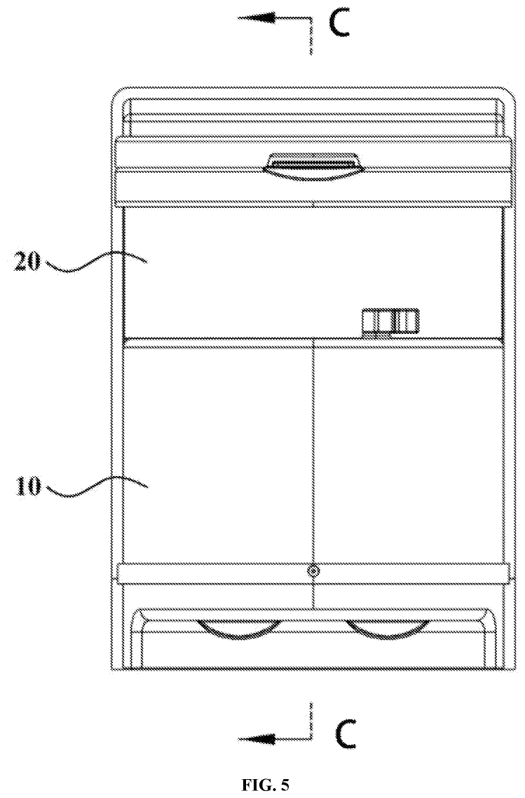

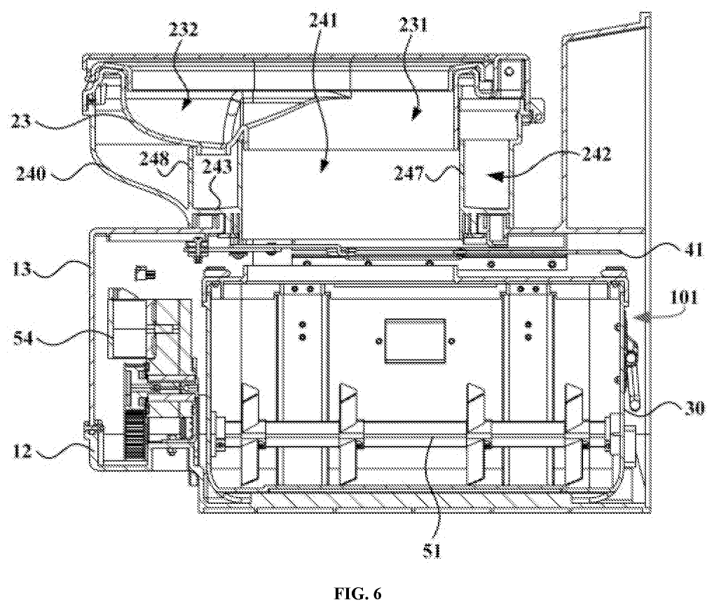

Referring to FIGS. 5 and 6, when the toilet tank 23 is assembled with the seat body 24, a bottom wall of the toilet tank 23 may close off the holding groove 242 to prevent odor of urine from spreading outward.

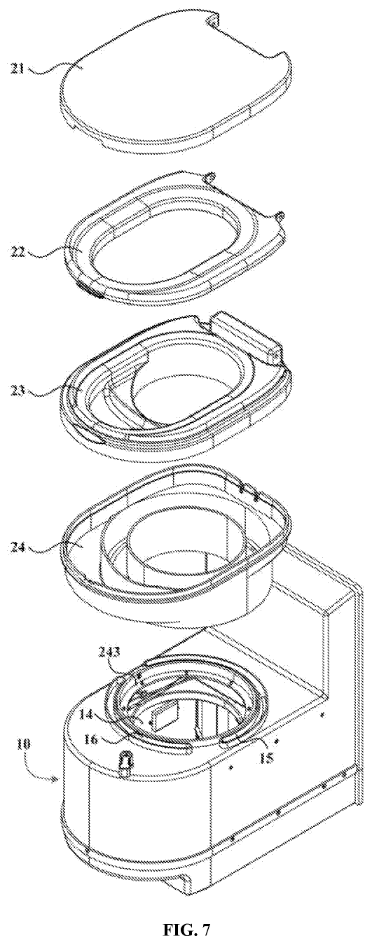

Referring to FIG. 7, in some embodiments, the base 10 defines a first arcuate groove 15 around the top opening 14, the first arcuate groove 15 having a liquid drainage outlet. A bottom wall of the holding groove 242 has a through hole 2421, and the seat body 24 further includes a dispensing tube section 246 extending downwardly from the bottom wall of the holding groove 242 into the first arcuate groove 15. The liquid in the holding groove 242 can enter the first arcuate groove 15 through the dispensing tube section 246 and is discharged outwardly through the liquid drainage outlet.

In some embodiments, a filter material capable of filtering the urine may be arranged in the holding groove 242. The filter material may be activated carbon or the like. The urine is filtered in the holding groove 242 and then enters the first arcuate groove 15, where it is discharged to the outside through the liquid drainage outlet and a liquid drainage pipeline connected to the liquid drainage outlet. When the toilet is applied in an RV, the liquid drainage pipeline may be utilized to introduce the filtered urine into a gray water tank.

In other embodiments, instead of placing a filter material for filtering the urine in the holding groove 242, a urine treatment device may be arranged outside the toilet to treat the urine. The urine treatment device may, for example, filter the urine. Specifically, after the urine enters the first arcuate groove 15 through the holding groove 242, it is discharged to the urine treatment device through a liquid drainage outlet and a liquid drainage pipeline connected to the liquid drainage outlet. When the toilet is applied in an RV, the treated urine in the urine treatment device may be discharged to a gray water tank.

The dispensing tube section 246 remains disposed within the first arcuate groove 15 as the seat body 24 rotates around the top opening 14. In such embodiments, the rotation angle of the toilet seat 20 is limited by the dispensing tube section 246, and it is also possible to realize that when the toilet seat 20 is rotated, all of the urine can be ensured to enter the first arcuate groove 15 without overflowing.

In the embodiments of the present disclosure, the holding groove 242 for collecting urine is arranged around the channel 241 in the seat body 24. When the seat body 24 is rotated around the top opening 14, the dispensing tube section 246 remains disposed in the first arcuate groove 15, such that when the toilet seat 20 is rotated, it is still possible to ensure that the urine flows smoothly from the holding groove 242 to the first arcuate groove 15. In addition, because the base 10 remains stationary, the pipeline connected to the liquid drainage outlet for discharging the urine outwardly will not be bent or twisted by the influence of the rotation, thereby realizing the rotation of the toilet seat 20 while ensuring the smooth discharge of the urine.

In some embodiments, referring to FIGS. 6 and 11, the seat body 24 may include: a shell 240, a barrel 247, an annular plate 243, and a ribbed plate 248. The shell 240 has an upper opening for connecting to the toilet tank 23 and a lower opening for facing the top opening 14. The barrel 247 defines to form the channel 241, and the barrel 247 is formed on an inside of the lower opening. The annular plate 243 is connected to the barrel 247 and the shell 240. The ribbed plate 248 extends upwardly over at least a portion of a radially outer edge of the annular plate 243, to define the holding groove 242 in conjunction with the annular plate 243, the barrel 247, and the shell 240. In the illustrated embodiments, the holding groove 242 is annular in shape. A portion of an outer sidewall of the holding groove 242 is provided by the shell 240, thereby reducing the weight and machining difficulty of the seat body 24.

Referring to FIGS. 6 and 10, the annular plate 243 may be connected to a lower portion of the barrel 247 and a lower portion of the shell 240, and the lower portion of the barrel 247, the lower portion of the shell 240, and the annular plate 243 collectively define an annular groove 245 with an opening facing downward. The first arcuate groove 15 is disposed within the annular groove 245. As the toilet seat 20 rotates relative to the base 10, the first arcuate groove 15 slides within the annular groove 245, thereby increasing the stability of the toilet seat 20 and the base 10 during the rotational fit.

Further, the base 10 defines a second arcuate groove 16 around the top opening 14, the second arcuate groove 16 facing the first arcuate groove 15, and both the second arcuate groove 16 and the first arcuate groove 15 being disposed within the annular groove 245. In such embodiments, the second arcuate groove 16 and the first arcuate groove 15 together support the seat body 24, thereby further increasing the stability of the toilet seat 20.

The toilet seat 20 may include: a toilet mat 22 and a toilet lid 21. The toilet mat 22 is in an annular structure. Rear ends of the toilet mat 22 and the toilet lid 21 are each rotatably arranged at a rear end of the toilet tank 23. The user can sit on the toilet mat 22 when using the toilet. The toilet lid 21 can fit over the toilet pad 22.

In some embodiments, the toilet may further be arranged with a fan for accelerating odor dispersion. The fan may run continuously during the usage of the toilet.

In the related art, a microbial toilet is of a one-piece type. When pouring out the microbial degradation strains as well as the excrement (referred to as materials) after fermentation, it is necessary to invert the microbial toilet such that the materials are poured out through an upper opening of the toilet. Such an operation requires a lot of effort to lift and invert the microbial toilet due to the heavy weight thereof, and it is easy to contaminate an upper surface of the toilet, which is not hygienic.

In further related techniques, the microbial toilet is designed in a split design. For example, a movable biodegradation box is arranged below the toilet seat. When the materials in the biodegradation box are required to be replaced, the biodegradation box is taken out and dumped separately. In the biodegradation box, in order to improve the mixing effect of the excrement with the microbial degradation strains, as well as to make the excrement in full contact with the air, a stirring blade is usually arranged in the biodegradation box, and the stirring blade is driven to rotate by a motor and a transmission member. The motor and the transmission member are usually fixedly arranged on the biodegradation box, and when the materials in the biodegradation box are required to be replaced, the motor, the transmission member, and the biodegradation box are required to be removed together. Such a design increases the weight of the biodegradation box. In addition, when dumping the materials, the biodegradation box is required to be knocked to accelerate the fall of the materials, and the operation of knocking the biodegradation box is easy to damage the motor, as well as to cause wear and tear of the transmission member.

As shown in FIGS. 1 to 4, the toilet in the embodiments of the present disclosure includes: a base 10, a toilet seat 20, a biodegradation container 30, a mixing portion, and a driving portion. A holding cavity 101 is defined inside the base 10. The toilet seat 20 is arranged on the base 10. An interior of the biodegradation container 30 is filled with a biodegradation filler, and the biodegradation container 30 is movably disposed within the holding cavity 101 and configured to receive excrement from the toilet seat 20 and decompose the excrement.

The mixing portion is configured to mix the biodegradation filler within the biodegradation container 30. The mixing portion includes at least one mixing shaft 51 and at least one joint respectively connected to the at least one mixing shaft 51. The at least one joint is arranged on an outer side of a peripheral wall of the biodegradation container 30. The driving portion is arranged on the base 10 opposite the joint in the holding cavity 101, for driving the mixing portion to rotate. The driving portion includes at least one joint fit portion respectively plugged and mated with the at least one joint. When the biodegradation container 30 is moved in a direction proximate to the driving portion, each joint fit portion is respectively plug-fit with a corresponding joint. When the biodegradation container 30 is moved in a direction away from the driving portion, each joint fit portion is respectively disengaged from a corresponding joint.

In the toilet in the embodiments of the present disclosure, due to the provision of the joint connected to the mixing shaft 51 on the outer side of the peripheral wall of the biodegradation container 30, the provision of the driving portion on the base 10, and the provision of the joint fit portion of the driving portion which is plugged and mated with the joint, the joint fit portion is plugged and mated with the joint when the biodegradation container 30 is moved in the direction close to the driving portion, and the joint fit portion is disengaged from the joint when the biodegradation container 30 is moved in the direction far away from the driving portion. In this way, when the materials are required to be replaced, it is only necessary to pull the biodegradation container 30 in a direction away from the driving portion to disengage the connection between the driving portion and the mixing shaft 51. After the materials are replaced, the connection between the driving portion and the mixing shaft 51 is established by pushing the biodegradation container 30 in a direction towards the driving portion, which makes the operation very convenient.

It can be seen that the toilet provided by the embodiments of the present disclosure is capable of removing the biodegradation container 30 for separate dumping treatment, without adversely affecting the motor and the transmission member. Since there is no need to flush with water after defecation, the toilet provided by the embodiments of the present disclosure is suitable for use in RV or in areas where water is scarce. In some embodiments, the toilet may be a vehicle-mounted toilet.

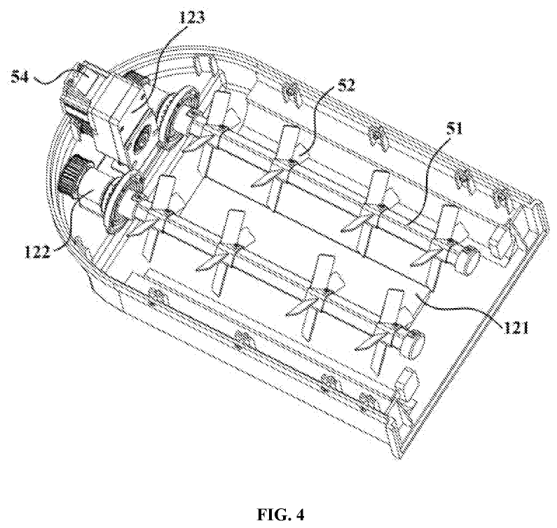

The mixing portion may further include blades 52 arranged on the mixing shaft 51. Referring to FIG. 4, in the illustrated embodiments, the mixing shaft 51 is arranged with multiple sets of blades 52 at intervals, each set of blades 52 including four blades 52 evenly spaced in a radial direction.

In some embodiments, the joint and the joint fit portion may be axially plug-in fit by means of a keyway, utilizing a non-annular perimeter mating surface for transmission. For example, the joint may be a rectangular protrusion and the joint fit portion may be a rectangular slot, and axial plug-in and transmission is realized by means of the mating of the rectangular protrusion and the rectangular slot.

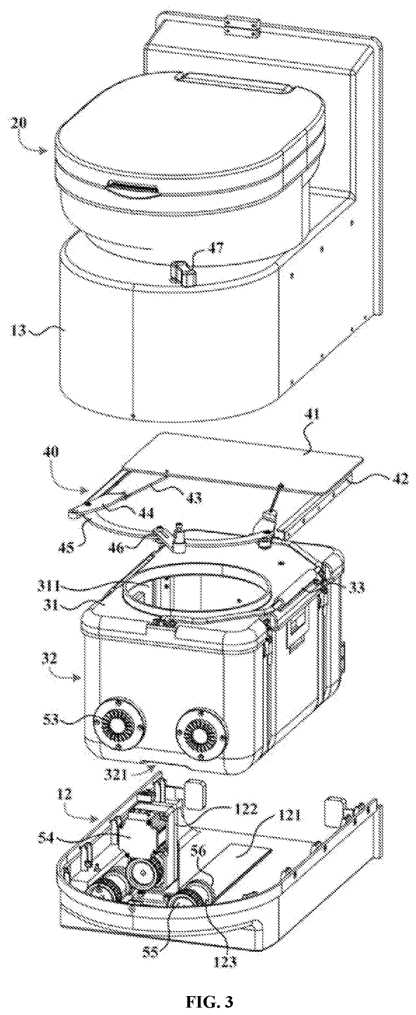

Referring to FIGS. 3 and 4, in some embodiments, each joint is a first end gear 53. An end surface of the first end gear 53 back away from the mixing shaft 51 is arranged with first end teeth. Each joint fit portion is a second end gear 56. An end surface of the second end gear 56 facing the first end teeth is arranged with second end teeth. When the first end teeth are mated with the second end teeth in an axial plug-in fit, the second end teeth mesh with the first end teeth. Compared to the plug-in transmission method utilizing a keyway, the embodiments of the present disclosure are less prone to wear and inefficiency by utilizing two end teeth to achieve mutual plug-in engagement.

Specifically, the holding cavity 101 has a lateral opening 11 in a predetermined direction, and the biodegradation container 30 is configured to enter the holding cavity 101 through the lateral opening 11. A guide portion 321 is a guiding slot arranged on a bottom of the biodegradation container 30 extending in the predetermined direction, and a guide fit portion 121 is a guiding protrusion arranged on a bottom wall of the holding cavity 101 extending in the predetermined direction. Alternatively, the guide portion 321 is a guiding protrusion arranged on the bottom of the biodegradation container 30 extending in the predetermined direction, and the guide fit portion 121 is a guiding slot arranged on the bottom wall of the holding cavity 101 extending in the predetermined direction.

It is readily understood that in other embodiments, the guide portion 321 may be arranged on a side wall of the biodegradation container 30, and accordingly, the guide fit portion 121 is arranged on a side wall of the holding cavity 101.

The predetermined direction may be, for example, a front-to-back direction of the toilet. A rearward-facing opening in communication with the holding cavity 101 may be defined on the back side of the base 10. When the biodegradation container 30 is put in from the rearward-facing opening, the biodegradation container 30 may be pushed forward along the guide fit portion 121, which allows the joint fit portion to align with the joint and realize the plug-in fit. When the biodegradation container 30 is required to be removed from the rearward-facing opening, the biodegradation container 30 may be pushed backward along the guide fit portion 121, which allows the joint fit portion to disengage from the joint.

In some embodiments, the mixing portion may include one mixing shaft 51.

In other embodiments, the mixing portion may include two mixing shafts 51, and the driving portion includes: a motor 54 and two joint fit portions plugged and mated to two joints, respectively. The motor 54 may be connected to the two joint fit portions through a synchronous belt pulley 55, so as to ensure the transmission effect and reduce noise.

The motor 54 may drive the mixing shaft 51 to forward and reverse rotation. The motor 54 and the two joint fit portions may be mounted on the bottom wall of the holding cavity 101 by means of a bracket 122. Compared to being mounted on a side wall (e.g., on a front wall opposite the rearward-facing opening) of the holding cavity 101, mounting the motor 54 and the two joint fit portions on the bottom wall is conducive to more stability of the toilet as a whole, and is conducive to reducing vibration.

In some embodiments, a contact surface of the biodegradation container 30 is arranged with a heating member. The heating member can create a suitable temperature for microbial degradation, which can increase the rate of degradation.

The biodegradation container 30 further includes: a body 32 and a cover 31, the cover 31 being detachably connected to the body 32, the cover 31 having a container opening 311 for aligning with the top opening 14 to receive excrement from the channel 241. The cover 31 is detachable from the body 32 by means of a buckle structure. The biodegradation container 30 further includes a carrying handle 33, rotatably disposed on the cover 31.

Referring to FIG. 3, the base 10 may include a bottom base 12 and an upper shell 13, with the top opening 14 defined on the upper shell 13. The bottom base 12 includes a bottom wall and an enclosure extending upwardly from the bottom wall, and the upper shell 13 includes a top wall and a side wall extending downwardly from the top wall. The upper shell 13 and the bottom base 12 are connected to collectively define the holding cavity 101. The driving portion may be mounted to the bottom base 12 by means of the bracket 122. When the driving portion is required to be serviced or replaced, the upper shell 13 may be removed from the bottom base 12 for ease of operation.

In some embodiments, the toilet may further include: a baffle assembly 40 for operably opening or closing the top opening 14. Specifically, when the toilet is in use, the baffle assembly 40 is operated to open the top opening 14. When the toilet is not in use, the baffle assembly 40 is operated to close the top opening 14, thereby preventing odors in the biodegradation container 30 from spreading outward. The baffle assembly 40 may also be utilized to close the top opening 14 when only the urine hopper 232, referred to below, is in use to avoid outward dispersion of odors.

Referring to FIG. 3, the baffle assembly 40 includes: two baffle slides 42, a baffle 41, two link assemblies, a linkage member 46, and a toggle member 47. The two baffle slides 42 are disposed opposite each other on a perimeter wall of the base 10. The baffle 41 is slidably disposed on the two baffle slides 42. The two link assemblies are disposed on both sides of the baffle 41. The linkage member 46 is connected to the two link assemblies. The toggle member 47 is connected to linkage member 46, and when toggle member 47 is toggled, the linkage member 46 and the two link assemblies drive the baffle 41 to slide relative to the two baffle slides 42, thereby achieving the opening or closing of the top opening 14.

The toggle member 47 may extend outwardly from within the holding cavity 101 to an outside of the base 10 to facilitate user operation. The linkage member 46 is arranged with a slide slot.

Each link assembly includes: a first link 43, a second link 44, and a third link 45. An end of the first link 43 is hingedly connected to the baffle 41, the other end of the first link 43 is hingedly connected to an end of the second link 44, and the other end of the second link 44 is connected to a top wall of the holding cavity 101. An end of the third link 45 is hingedly connected to a middle of the second link 44, and the other end of the third link 45 is hingedly connected to the third link 45 of the other link assembly. The articulated shafts of the two third links 45 are slidably disposed in the slide slot of the linkage member 46. The third link 45 is arcuate, with a circle center of the arcuate being near the baffle 41. The linkage member 46 is also further with a vertically extending column with which the toggle member 47 is plugged and mated. When the toggle member 47 is toggled in a horizontal direction, the baffle 41 slides relative to the two baffle slides 42 under the action of the link assembly.

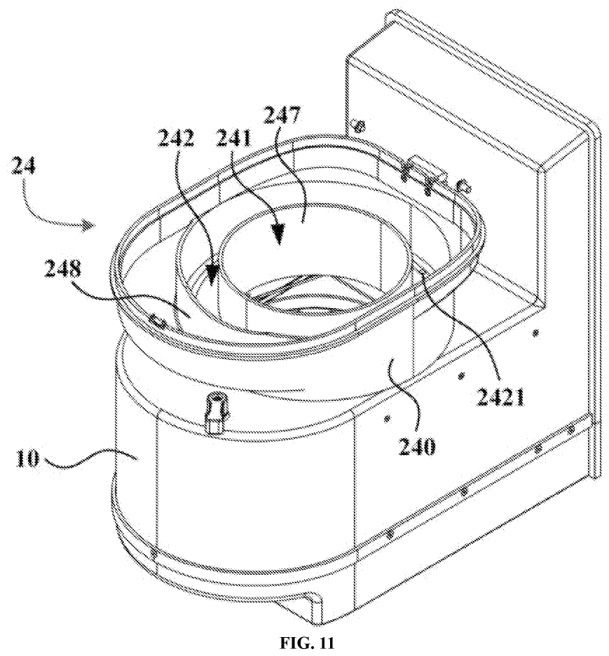

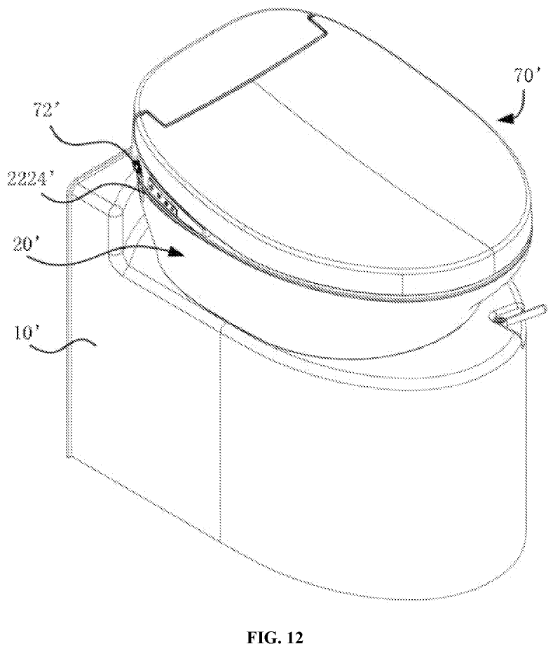

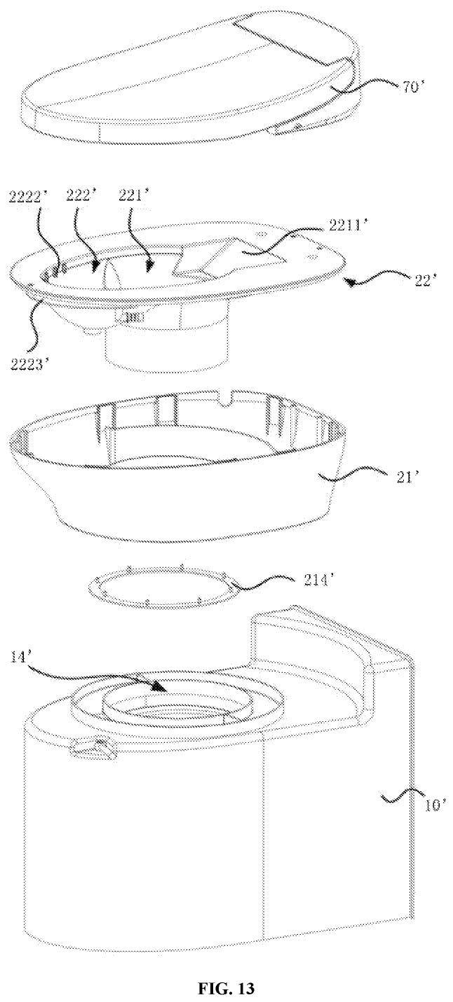

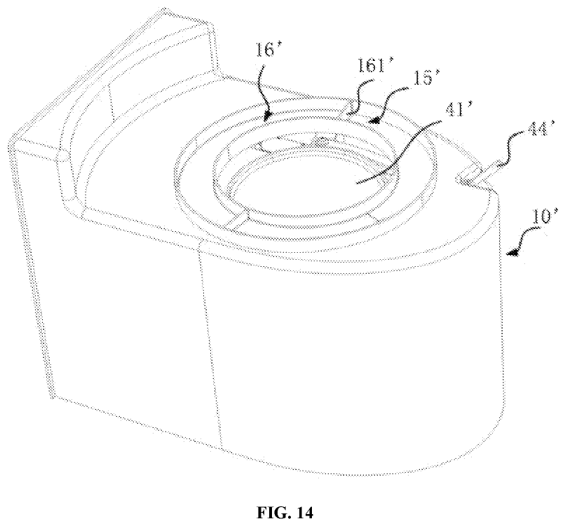

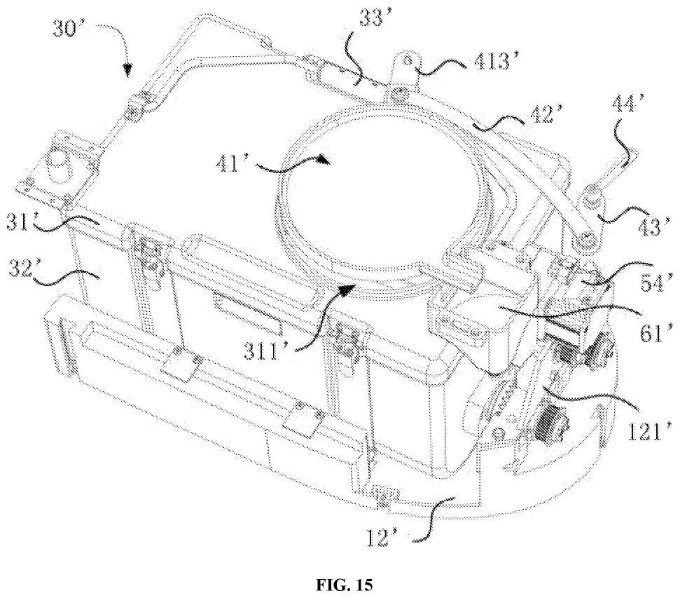

As shown in FIGS. 12 to 24, some embodiments of the present disclosure provide another toilet. As shown in FIGS. 12 to 16, the toilet includes: a base 10′, a toilet seat 20′, a biodegradation container 30′, and a liquid collection tray 41′.

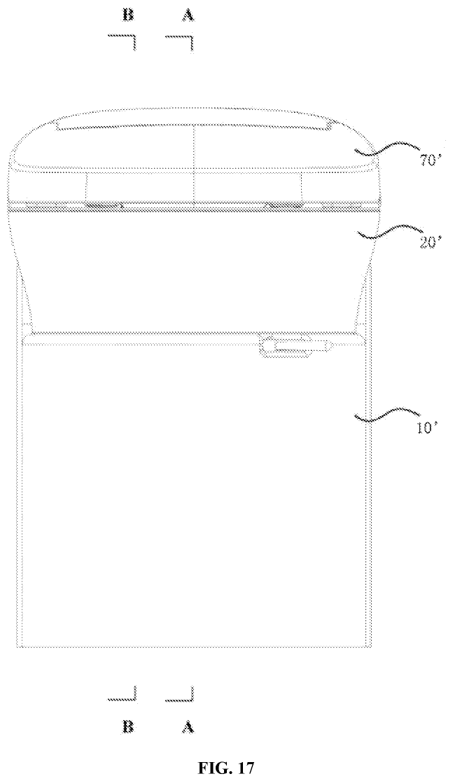

A holding cavity 101′ is defined inside the base 10′. The toilet seat 20′ is arranged on the base 10′. Referring to FIGS. 17 to 20, the toilet seat 20′ defines a fecal discharge channel 221′ for receiving excrement. The biodegradation container 30′ is arranged in the holding cavity 101′ for receiving excrement from the fecal discharge channel 221′ and decomposing the excrement. The liquid collection tray 41′ is disposed within the holding cavity 101′ configured to be operable to be in a first position staggered from the fecal discharge channel 221′ or in a second position facing the fecal discharge channel 221′. When the liquid collection tray 41′ is in the first position, excrement from the fecal discharge channel 221′ is allowed to enter the biodegradation container 30′. When the liquid collection tray 41′ is in the second position, the liquid collection tray 41′ is capable of receiving liquid from the fecal discharge channel 221′.

By arranging the liquid collection tray 41′, the embodiments of the present disclosure allow excrement from the fecal discharge channel 221′ to enter the biodegradation container 30′ when the toilet is used by having the liquid collection tray 41′ in the first position. After the toilet is used, when the toilet is flushed, by placing the liquid collection tray 41′ in the second position, the liquid collection tray 41′ can be utilized to receive the liquid from the fecal discharge channel 221′ in order to avoid the liquid from flowing into the biodegradation container 30′ and adversely affecting the biodegradation colonies of strains. The liquid collection tray 41′, when in the second position, may further prevent odors in the biodegradation container 30′ from spreading outwardly, while making the toilet more aesthetically pleasing.

In some embodiments, the toilet further includes: a liquid collection container 61′, arranged within the holding cavity 101′. The liquid received by the liquid collection tray 41′ can flow into the liquid collection container 61′. In some embodiments, the liquid within the liquid collection container 61′ can be drained to the exterior through a pipeline. For example, when the toilet is used in an RV, a pipeline may be utilized to introduce the liquid within the liquid collection container 61′ to a gray water tank.

In some embodiments, the liquid collection tray 41′ is in communication with the liquid collection container 61′ through a pipeline. In other embodiments, an opening 611′ is defined on a top of the liquid collection container 61′. For example, the liquid collection container 61′ may be a trough with an opening upward.

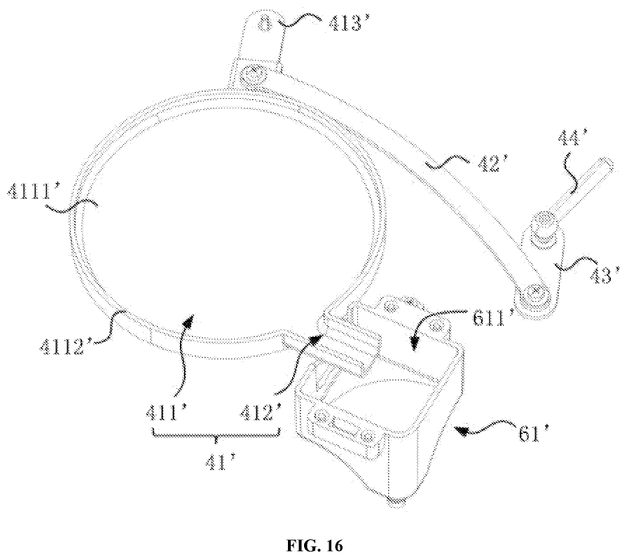

Referring to FIG. 16, the liquid collection tray 41′ includes: a tray body 411′ and a deflector groove 412′ in communication with the tray body 411′. When the liquid collection tray 41′ is in the first position, the tray body 411′ is disposed directly below the fecal discharge channel 221′, an outlet of the deflector groove 412′ is disposed directly above the opening 611′ of the liquid collection container 61′, and the liquid in the liquid collection tray 41′ can flow into the liquid collection container 61′ under gravity.

In some embodiments, the tray body 411′ may include a tray base plate 4111′ and a flange 4112′ extending upwardly from a peripheral edge of the tray base plate 4111′. An upper surface of the tray bottom plate 4111′ may extend downwardly at an angle from a side away from the deflector groove 412′ toward the deflector groove 412′, to facilitate rapid flow of the liquid in the liquid collection tray 41′ into the liquid collection container 61′ under gravity, thereby avoiding liquid residue.

In some embodiments, the liquid collection tray 41′ may be driven by a motor to switch between the first position and the second position. In other embodiments, the toilet further includes: an operating assembly for driving the liquid collection tray 41′ to switch between the first position and the second position.

In some embodiments, the liquid collection tray 41′ includes a tray body 411′ and a connecting member 413′ disposed on a side of the tray body 411′, the connecting member 413′ being pivotally connected to the base 10′. The operating assembly includes: a first linkage member 42′, a second linkage member 43′, and a toggle member 44′. The toggle member 44′ and the second linkage member 43′ are rigidly connected and pivoted to the base 10′; the first linkage member 42′ is pivotally connected to the connecting member 413′ and the second linkage member 43′, respectively. When the toggle member 44′ is toggled, the first linkage member 42′ and the second linkage member 43′ drive the liquid collection tray 41′ to rotate with respect to the base 10′ such that the liquid collection tray 41′ is in the first position or is in the second position. The toggle member 44′ may extend outwardly from within the holding cavity 101′ to an outside of the base 10′ to facilitate user operation.

In other embodiments, a slide fit may be utilized to allow the liquid collection tray 41′ to be slidably switched between the first position and the second position.

The toilet further includes: a smart toilet lid 70′ arranged on the toilet seat 20′. The smart toilet lid 70′ may be a commercially available universal product and is connected to the toilet seat 20′ by screws. The smart toilet lid 70′ can realize functions such as heating a toilet rim and flushing after usage of the toilet.

The smart toilet lid 70′ includes a fecal flush port 71′ for providing flushing water to the fecal discharge channel 221′. The smart toilet lid 70′ is arranged with a fecal flush inlet 72′, which is connected to the fecal flush port 71′ through a pipeline.

A position of the toilet seat 20′ facing the fecal flush inlet 71′ is formed with the deflector groove 2211′ connected to the fecal discharge channel 221′ to introduce flushing water from the fecal flush port 71′ into the fecal discharge channel 221′. The fecal flush port 71′ may be disposed rearwardly above the fecal discharge channel 221′.

The dimensions of the fecal discharge channel 221′ may be set larger to avoid excrement remaining on the fecal discharge channel 221′. In some embodiments, the diameter of the fecal discharge channel 221′ may be substantially the same as a dimension in a width direction of the toilet rim of the smart toilet lid 70′. In some embodiments, the diameter of the fecal discharge channel 221′ is slightly greater than the dimension in the width direction of the toilet rim. For example, the diameter of the fecal discharge channel 221′ may be 0.5-3 cm greater than the dimension in the width direction of the toilet rim.

A top surface of the base 10′ defines a top opening 14′ in communication with the holding cavity 101′. The toilet seat 20′ may include: a seat body 21′ and a toilet tank 22′ detachably disposed on the seat body 21′.

The seat body 21′ is configured to be rotatably disposed around the top opening 14′ on the base 10′. When the seat body 21′ is rotated around the top opening 14′, the entire toilet seat 20′ is rotated together. The user can adjust the position of the toilet seat 20′ as needed, making full use of space.

The seat body 21′ further includes an annular restriction member 214′ detachably connected to a bottom of a central channel 211′, the annular restriction member 214′ being disposed in the holding cavity 101′. The diameter of the top opening 14′ is less than an outer diameter of the annular restriction member 214′ and greater than or equal to an inner diameter of the annular restriction member 214′. By arranging the annular restriction member 214′, the seat body 21′ may be prevented from separating from the base 10′. The annular restriction member 214′ may be an annular plate.

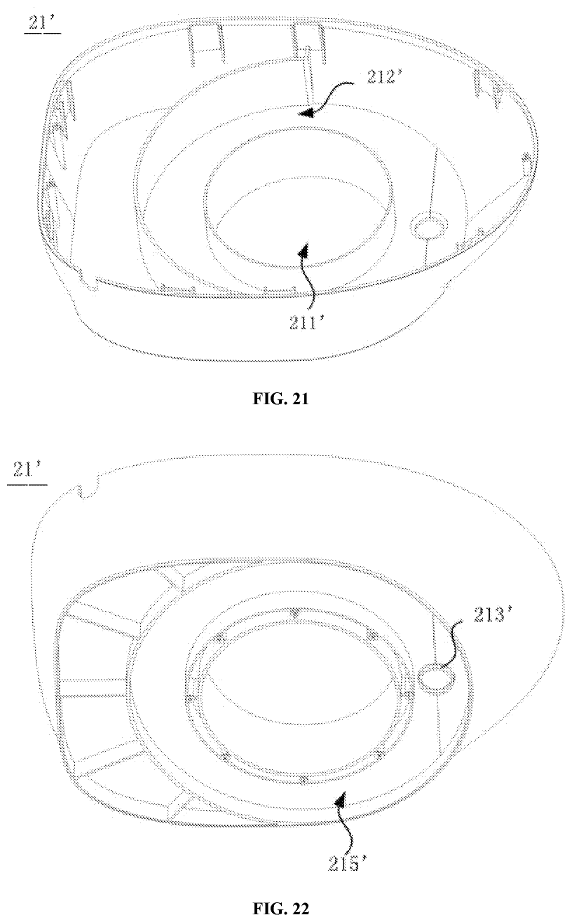

Referring to FIGS. 21 and 22, the seat body 21′ defines a central channel 211′ facing the top opening 14′ and a urine filtering groove 212′ disposed radially outward of the central channel 211′. The urine filtering groove 212′ is configured to fill with a filter material for filtering urine. The filter material may be activated carbon or the like.

When the toilet tank 22′ is assembled with the seat body 21′, the toilet tank 22′ may close the urine filtering groove 212′ so as to avoid odor of the urine from spreading outward.

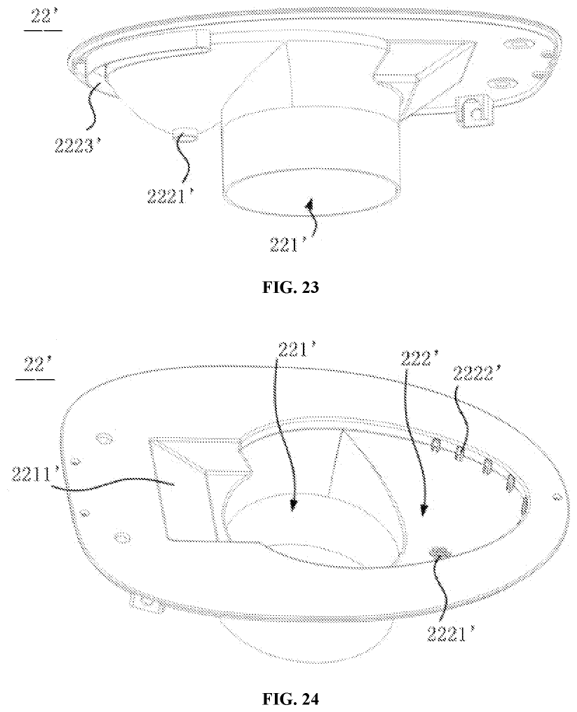

Referring to FIGS. 23 and 24, the toilet tank 22′ is formed with a urine hopper 222′ for collecting urine and a fecal discharge channel 221′. The embodiments of the present disclosure can well realize the separation of urine and feces due to the separate provision of the urine hopper 222′ and the fecal discharge channel 221′, which is conducive to the biodegradation of feces.

The fecal discharge channel 221′ extends downwardly through the central channel 211′. The urine hopper 222′ has a urinary outlet 2221′ for discharging urine to the urine filtering groove 212′.

The urine hopper 222′ may be arranged with a urinal flush port 2222′ for providing flushing water to the urine hopper 222′; the flushing water passes through the urinary outlet 2221′ into the urine filtering groove 212′.

In some embodiments, the base 10′ is arranged with a urinal flush inlet 2224′ connected to the urinal flush port 2222′ through a pipeline.

The number of the urinal flush ports 2222′ may be a plurality, and the multiple urinal flush ports 2222′ are arranged along a perimeter of the urine hopper 222′. A strip reservoir 2223′ may be arranged on a side of the urine hopper 222′ facing the seat body 21′, the strip reservoir 2223′ being connected to the urinal flush inlet 2224′ through a pipeline. The strip reservoir 2223′ is in communication with the multiple urinal flush inlets 2222′ to provide flushing water to the respective urinal flush inlets 2222′.

The toilet tank 22′ and the seat body 21′ may be screwed together to facilitate replacement of the filter material for treating urine.

The base 10′ is arranged with a liquid transit groove 15′ formed on an outside of the top opening 14′ for receiving liquid from the urine filtering groove 212′ and transporting the liquid to the liquid collection container 61′. The liquid staging tank 15′ may be curved. A bottom of the urine filtering groove 212′ has a dispensing tube section 213′, the dispensing tube section 213′ extending downwardly into the liquid transit groove 15′. When the toilet seat 20′ is rotated relative to the toilet base 10′, the dispensing tube section 213′ remains in the liquid transit groove 15′ as it rotates. In such embodiments, the rotation angle of the toilet seat 20′ is limited by the dispensing tube section 213′, and it is also possible to realize that when the toilet seat 20′ is rotated, all of the liquid from the urine filtering groove 212′can be ensured to enter into the liquid transit groove 15′ without overflowing.

The liquid from the urine filtering groove 212′ enters the liquid transit groove 15′ through the dispensing tube section 213′. The liquid transit groove 15′ has a liquid drainage outlet 151′, and the liquid drainage outlet 151′ may be connected to the liquid collection container 61′ by a pipeline; or a top opening of the liquid collection container 61′ may be positioned directly below the liquid drainage outlet 151′, such that the liquid flowing out of the liquid drainage outlet 151′ can directly enter the liquid collection container 61′.

In the embodiments of the present disclosure, the urine filtering groove 212′ for filtering urine is arranged in the seat body 21′. When the seat body 21′ is rotated around the top opening 14′, the dispensing tube section 213′ of the urine filtering groove 212′ can remain disposed in the liquid transit groove 15′, such that when the toilet seat 20′ is rotated, it is still possible to ensure that the urine flows smoothly from the urine filtering groove 212′ to the liquid transit groove 15′; avoiding that the pipeline is bent or twisted under the influence of the rotation of the toilet seat 20′ when the liquid in the urine filtering groove 212′ is exported by the use of the pipeline, such that the toilet can realize the rotation of the toilet seat 20′ while ensuring the smooth discharge of the urine.

In some embodiments, the base 10′ is arranged with an annular groove 16′ around the top opening 14′, and the annular groove 16′ may serve as the liquid transit groove 15′. In some embodiments, the annular groove 16′ is arranged with at least two spacers 161′ to separate the annular groove 16′ to form at least two arcuate grooves. The liquid transit groove 15′ may be formed by one of the arcuate grooves. A bottom wall of the liquid transit groove 15′ may include a slope, such that liquid in the liquid transit groove 15′ can flow into the liquid collection container 61′ as quickly as possible.

A bottom of the seat body 21′ may further define an annular groove 215′ with an opening facing downward, with the annular groove 16′ disposed radially inward of the annular groove 215′. As the toilet seat 20′ rotates relative to the base 10′, the annular groove 16′ slides within the annular groove 215′, increasing the rotational stability of the toilet seat 20′ and the base 10′.

When the toilet in the embodiments of the present disclosure is in use, urine or urine flushing water enters the urine filtering groove 212′ through the urine hopper 222′, and flows into the liquid transit groove 15′ on the base 10′ through the dispensing tube section 213′, and flows into the liquid collection container 61′ inside the holding cavity 101′ through an outlet.

The toggle member 44′ can be toggled such that the liquid collection tray 41′ is in the first position, enabling the feces to enter the biodegradation container 30′ directly through the fecal discharge channel 221′. After use, the toggle member 44′ is triggered back to an original position, at which time the liquid collection tray 41′ is in the second position to block the fecal discharge channel 221′. S flushing nozzle button is pressed, such that a flushing nozzle operates, and water enters the fecal discharge channel 221′ followed by the liquid collection tray 41′ and then flows into the liquid collection container 61′.

In order to improve the mixing effect of the excrement with the microbial degradation strains, as well as to make the excrement in full contact with the air, the toilet may further include a mixing portion as well as a driving portion. The mixing portion is configured to mix the biodegradation filler in the biodegradation container 30. The product after decomposition is made into organic fertilizer.

The driving portion usually includes a motor and a transmission member. In the related art, the driving portion is usually fixedly mounted on the biodegradation container 30′, and when the materials inside the biodegradation container 30′ are required to be replaced, the driving portion and the biodegradation container 30′ are required to be taken out together. Such a design increases the weight of the biodegradation container 30′. In addition, when dumping the materials, the biodegradation container 30′ is required to be knocked to accelerate the fall of the materials, and the operation of knocking the biodegradation container 30′ is easy to damage the motor, as well as to cause wear and tear of the transmission member.

In the embodiments of the present disclosure, the mixing portion includes a mixing shaft 51′ and a joint connected to the mixing shaft 51′, the joint being arranged on an outer side of a peripheral wall of the biodegradation container 30′. The driving portion is arranged on the base 10′ opposite the joint in the holding cavity 101′, for driving the mixing portion to rotate. The driving portion includes a joint fit portion plugged and mated with the joint. When the biodegradation container 30′ is moved in a direction close to the driving portion, the joint fit portion is plug-fit with the joint. When the biodegradation container 30′ is moved in a direction away from the driving portion, the joint fit portion and the joint are disengaged from each other.

As can be seen, for the toilet provided by the embodiments of the present disclosure, the biodegradation container 30′ can be removed for separate dumping treatment without adversely affecting the motor and the transmission member.

In the toilet in the embodiments of the present disclosure, due to the provision of the joint connected to the mixing shaft 51′ on the outer side of the peripheral wall of the biodegradation container 30′, the provision of the driving portion on the base 10′, and the provision of the joint fit portion of the driving portion which is plugged and mated with the joint, the joint fit portion is plugged and mated with the joint when the biodegradation container 30′ is moved in the direction close to the driving portion, and the joint fit portion is disengaged from the joint when the biodegradation container 30′ is moved in the direction far away from the driving portion. In this way, when the materials are required to be replaced, it is only necessary to pull the biodegradation container 30′ in a direction away from the driving portion to disengage the connection between the driving portion and the mixing shaft 51′. After the materials are replaced, the connection between the driving portion and the mixing shaft 51′ is established by pushing the biodegradation container 30′ in a direction towards the driving portion, which makes the operation very convenient.

Both ends of the mixing shaft 51′ can be rotatably supported through back-to-back angular contact ball bearings. A bearing sealing cover is designed to realize rotational sealing by O-ring. An end of the mixing shaft 51′ facing the driving portion is bearing connected with the joint.

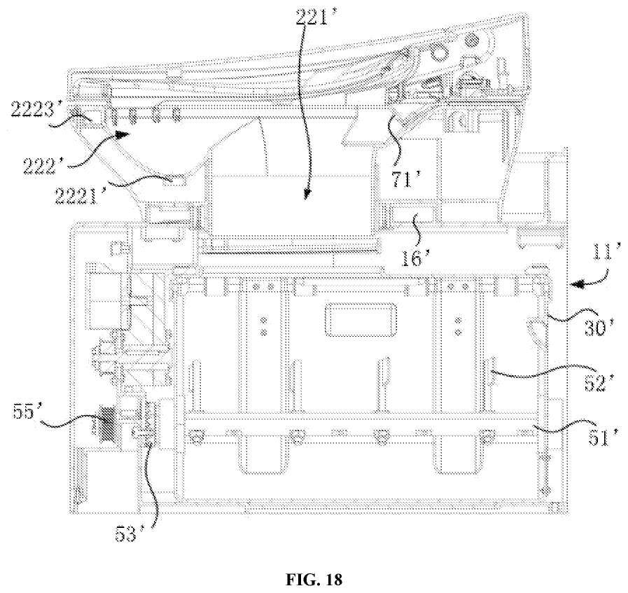

Referring to FIG. 18, the mixing portion further includes blades 52′ arranged on the mixing shaft 51′. The blades 52′ are spaced apart on the mixing shaft 51′.

In some embodiments, the joint and the joint fit portion may be axially plug-in fit by means of a keyway, utilizing a non-annular perimeter mating surface for transmission. For example, the joint may be a rectangular protrusion and the joint fit portion may be a rectangular slot, and axial plug-in and transmission is realized by means of the mating of the rectangular protrusion and the rectangular slot.

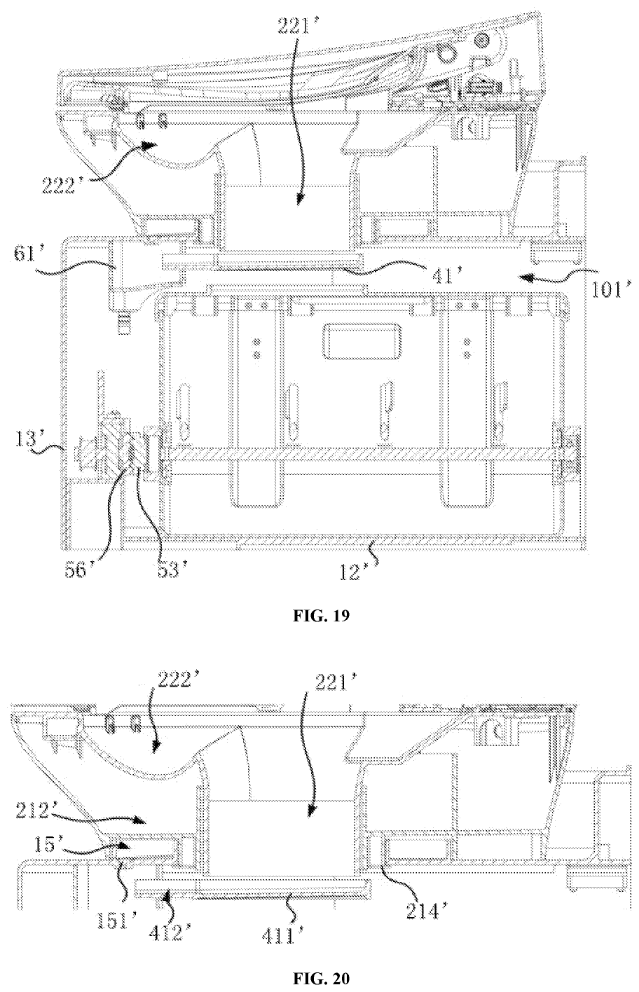

Referring to FIGS. 18 and 19, in some embodiments, each joint is a first end gear 53′. An end surface of the first end gear 53′ back away from the mixing shaft 51′ is arranged with first end teeth. Each joint fit portion is a second end gear 56′. An end surface of the second end gear 56′ facing the first end teeth is arranged with second end teeth. When the first end teeth are mated with the second end teeth in an axial plug-in fit, the second end teeth mesh with the first end teeth. Compared to the plug-in transmission method utilizing a keyway, the embodiments of the present disclosure are less prone to wear and inefficiency by utilizing two end teeth to achieve mutual plug-in engagement.

In some embodiments, the biodegradation container 30′ is arranged with a guide portion and a cavity wall of the holding cavity 101′ is arranged with a guide fit portion that cooperates with the guide portion. The joint fit portion may be aligned with the joint by a guiding action of the guide portion and the guide fit portion.

Specifically, the holding cavity 101′ has a lateral opening 11′ in a predetermined direction, and the biodegradation container 30′ is configured to enter the holding cavity 101′ through the lateral opening 11′. The guide portion is a guiding slot arranged on a bottom of the biodegradation container 30′ extending in the predetermined direction, and the guide fit portion is a guiding protrusion arranged on a bottom wall of the holding cavity 101′ extending in the predetermined direction. Alternatively, the guide portion is a guiding protrusion arranged on the bottom of the biodegradation container 30′ extending in the predetermined direction, and the guide fit portion is a guiding slot arranged on the bottom wall of the holding cavity 101′ extending in the predetermined direction.

It is readily understood that in other embodiments, the guide portion may be arranged on a side wall of the biodegradation container 30′, and accordingly, the guide fit portion is arranged on a side wall of the holding cavity 101′.

The predetermined direction may be, for example, a front-to-back direction of the toilet. A rearward-facing opening in communication with the holding cavity 101′ may be defined on the back side of the base 10′. When the biodegradation container 30′ is put in from the rearward-facing opening, the biodegradation container 30′ may be pushed forward along the guide fit portion, which allows the joint fit portion to align with the joint and realize the plug-in fit. When the biodegradation container 30′ is required to be removed from the rearward-facing opening, the biodegradation container 30′ may be pushed backward along the guide fit portion, which allows the joint fit portion to disengage from the joint.

In some embodiments, the mixing portion may include one mixing shaft 51′.

In other embodiments, the mixing portion may include two mixing shafts 51′, and the driving portion includes: a motor 54′ and two joint fit portions that are respectively plugged and mated with the two joints. The motor 54′ may be connected to the two joint fit portions through a synchronous belt pulley 55′, so as to ensure the transmission effect and reduce noise. The synchronous belt pulley 55′ is arranged with an expansion sleeve, such that the positioning and fixing of shaft system parts can be easily realized.

The motor 54′ can drive the mixing shaft 51′ to forward and reverse rotation. The motor 54′ and the two joint fit portions may be mounted on a bottom wall of the holding cavity 101′ by means of a bracket 121′. Compared to being mounted on a side wall (e.g., on a front wall opposite the rearward-facing opening) of the holding cavity 101′, mounting the motor 54′ and the two joint fit portions on the bottom wall is conducive to more stability of the toilet as a whole, and is conducive to reducing vibration.

In some embodiments, a contact surface of the biodegradation container 30′ is arranged with a heating member. The heating member can create a suitable temperature for microbial degradation, which can increase the rate of degradation.

The biodegradation container 30′ further includes: a body 32′ and a cover 31′, the cover 31′ being detachably connected to the body 32′, the cover 31′ having a container opening 311′ for aligning with the top opening 14′ to receive excrement from the central channel 211′. The cover 31′ is detachable from the body 32′ by means of a buckle structure. The biodegradation container 30′ further includes a carrying handle 33′ rotatably disposed on the cover 31′. The biodegradation container 30′ may be arranged with snap handles around the biodegradation container 30′ to facilitate handling.

The base 10′ may include a bottom base 12′ and an upper shell 13′, with the top opening 14′ defined in the upper shell 13′. The bottom base 12′ includes a bottom wall and an enclosure extending upwardly from a perimeter of a portion of the bottom wall, and the upper shell 13′ includes a top wall and a side wall extending downwardly from the top wall. The upper shell 13′ and the bottom base 12′ are connected to collectively define the holding cavity 101′. The driving portion may be mounted to the bottom base 12′ by means of the bracket 121′. When the driving portion is required to be serviced or replaced, the upper shell 13′ may be removed from the bottom base 12′ for ease of operation.

In some embodiments, a guide groove is defined on the bottom base 12′, and the biodegradation container 30′ is secured in position on the bottom base 12′ by mating with the guide groove and locking by a spring-loaded pin.

In some embodiments, the toilet may further be arranged with a fan to allow gases within the holding cavity 101′ to be vented outwardly through a pipeline. The fan may operate continuously during the usage of the toilet. The fan may be arranged at the lateral opening 11′ in the base 10′.

The above embodiments are only intended to illustrate the technical solution of the present disclosure, not to limit the same. Although the present disclosure has been described in detail with reference to the foregoing embodiments, those skilled in the art should understand that it is still possible to make modifications to the technical solution as recorded in the foregoing embodiments, or to make equivalent substitutions for some or all of the technical features therein. These modifications or substitutions do not take the essence of the corresponding technical solutions out of the scope of the technical solutions of the embodiments of the present disclosure.

What is claimed is:

1. A toilet, comprising:
a base, wherein a holding cavity is defined inside the base;
a toilet seat, arranged on the base; and
a biodegradation container, wherein an interior of the biodegradation container is filled with a biodegradation filler, the biodegradation container being movably disposed within the holding cavity and configured to receive excrement from the toilet seat and to decompose the excrement.

2. The toilet according to claim 1, wherein a top surface of the base defines a top opening in communication with the holding cavity; the toilet seat comprises a seat body and a toilet tank, the seat body being arranged on the base; the seat body defines a channel in communication with the top opening and a holding groove arranged around the channel; the toilet tank is arranged on the seat body, and the toilet tank is formed with a urine hopper for collecting urine and a fecal discharge groove in communication with the channel; the urine hopper defines a urine drainage outlet for discharging the urine into the holding groove.

3. The toilet according to claim 2, wherein the seat body is configured to be rotatably disposed on the base around the top opening.

4. The toilet according to claim 3, wherein the base defines a first arcuate groove around the top opening, the first arcuate groove having a liquid drainage outlet; a bottom wall of the holding groove has a through hole, and the seat body further comprises a dispensing tube section extending downwardly from the bottom wall of the holding groove into the first arcuate groove; liquid in the holding groove is capable of entering the first arcuate groove through the dispensing tube section and discharged outwardly through the liquid drainage outlet; the dispensing tube section remains disposed within the first arcuate groove in condition of the seat body rotating around the top opening.

5. The toilet according to claim 4, wherein the seat body comprises:
a shell, having an upper opening for connecting to the toilet tank and a lower opening for facing the top opening;
a barrel, defining the channel and formed on an inside of the lower opening;
an annular plate, connected to the barrel and the shell; and
a ribbed plate, extending upwardly over at least a portion of a radially outer edge of the annular plate, to define the holding groove in conjunction with the annular plate, the barrel, and the shell.

6. The toilet according to claim 5, wherein the annular plate is connected a lower portion of the barrel and a lower portion of the shell; the lower portion of the barrel, the lower portion of the shell, and the annular plate together define an annular groove with a downward-facing opening, and the first arcuate groove is disposed within the annular groove.

7. The toilet according to claim 6, wherein the base further defines a second arcuate groove around the top opening, the second arcuate groove facing the first arcuate groove; the second arcuate groove and the first arcuate groove are both disposed within the annular groove.

8. The toilet according to claim 2, wherein the seat body further comprises a restriction ring detachably connected to a bottom of the channel, the restriction ring being disposed within the holding cavity; a diameter of the top opening is less than an outer diameter of the restriction ring and greater than an inner diameter of the restriction ring.

9. The toilet according to claim 1, further comprising:
a mixing portion, configured to mix the biodegradation filler within the biodegradation container; wherein the mixing portion comprises a mixing shaft and a joint connected to the mixing shaft, the joint being arranged on an outer side of a peripheral wall of the biodegradation container; and
a driving portion, arranged on the base opposite the joint in the holding cavity for driving the mixing portion to rotate; wherein the driving portion comprises a joint fit portion to be plugged and mated with the joint; in response to the biodegradation container being moved in a direction proximate to the driving portion, the joint fit portion is plugged and mated with the joint; in response to the biodegradation container being moved in a direction away from the driving portion, the joint fit portion is disengaged from the joint.

10. The toilet according to claim 9, wherein the joint is a first end gear, and an end surface of the first end gear back away from the mixing shaft is arranged with first end teeth; the joint fit portion is a second end gear, and an end surface of the second end gear facing the first end teeth is arranged with second end teeth; in condition of the first end teeth being plugged and mated with the second end teeth axially, the second end teeth mesh with the first end teeth.

11. The toilet according to claim 10, wherein the biodegradation container is arranged with a guide portion, and a cavity wall of the holding cavity is arranged with a guide fit portion to match with the guide portion; the joint fit portion is configured to be aligned with the joint through a guiding action of the guide portion and the guide fit portion.

12. The toilet according to claim 11, wherein the holding cavity has a lateral opening in a predetermined direction; the guide portion is a guiding slot or a guiding protrusion arranged on a bottom of the biodegradation container extending in the predetermined direction, and the guide fit portion is a guiding protrusion or a guiding slot arranged on a bottom wall of the holding cavity extending in the predetermined direction; the biodegradation container is configured to enter the holding cavity through the lateral opening.

13. The toilet according to claim 10, wherein the mixing shaft comprises two mixing shafts; the joint comprises two joints, and the joint fit portion comprises two joint fit portions; the two joint fit portions are plugged and mated with the two joints in a one-to-one correspondence; the driving portion further comprises: a motor connected to the two joint fit portions through a synchronous belt pulley; the motor and the two joint fit portions are arranged on the bottom wall of the holding cavity.

14. The toilet according to claim 10, wherein the toilet seat is arranged with a channel running up and down; a top surface of the base defines a top opening in communication with the holding cavity, the channel being connected to the top opening; the biodegradation container further comprises: a body and a cover, the cover being detachably connected to the body, the cover having a container opening for aligning with the top opening to receive excrement from the channel; the toilet further comprises: a baffle assembly for operably opening or closing the top opening.

15. The toilet according to claim 14, wherein the baffle assembly comprises:
two baffle slides, disposed opposite each other on a perimeter wall of the base;
a baffle, slidably disposed on the two baffle slides;
two link assemblies, disposed on both sides of the baffle;
a linkage member, connected to the two linkage assemblies; and
a toggle member, connected to the linkage member;
in response to the toggle member being toggled, the linkage member and the two link assemblies drive the baffle to slide relative to the two baffle slides, thereby opening or closing the top opening.

16. A toilet, comprising:
a base, wherein a holding cavity is defined inside the base;
a toilet seat, arranged on the base and defining a fecal discharge channel for receiving excrement;
a biodegradation container, arranged in the holding cavity for receiving the excrement from the fecal discharge channel and decomposing the excrement; and
a liquid collection tray, arranged in the holding cavity and configured to be operable to be in a first position staggered from the fecal discharge channel or in a second position facing the fecal discharge channel; wherein in response to the liquid collection tray being in the first position, the excrement from the fecal discharge channel is allowed to enter the biodegradation container; in response to the liquid collection tray being in the second position, the liquid collection tray is capable of receiving liquid from the fecal discharge channel.

17. The toilet according to claim 16, further comprising: a liquid collection container, arranged within the holding cavity; the liquid received by the liquid collection tray is capable of flowing into the liquid collection container.

18. The toilet according to claim 17, wherein an opening is defined on a top of the liquid collection container; the liquid collection tray comprises: a tray body and a deflector groove in communication with the tray body; in response to the liquid collection tray being in the second position, the tray body is disposed directly below the fecal discharge channel, and an outlet of the deflector groove is disposed directly above the opening of the liquid collection container.

19. The toilet according to claim 18, wherein the tray body comprises a tray base plate and a flange extending upwardly from a peripheral edge of the tray base plate; an upper surface of the tray base plate extends downwardly at an angle from a side away from the deflector groove toward the deflector groove.

20. The toilet according to claim 16, further comprising: an operating assembly for driving the liquid collection tray to switch between the first position and the second position; the liquid collection tray comprises a tray body and a connecting member disposed on a side of the tray body, the connecting member pivotally connected to the toilet base; the operating assembly comprises: a first linkage member, a second linkage member, and a toggle member; the toggle member and the second linkage member are rigidly connected and pivotally connected to the toilet base; the first linkage member is pivotally connected to the connecting member and the second linkage member, respectively; in response to the toggle member being toggled, the first linkage member and the second linkage member drive the liquid collection tray to rotate with respect to the base such that the liquid collection tray is in the first position or the second position.
